(19) United States
(12) Patent Application Publication
(10) Pub. No.: US 2024/0369397 A1
(43) Pub. Date: Nov. 7, 2024

(54) SYSTEMS AND METHODS FOR USE AT AN EXIT OF A RETAIL FACILITY

(71) Applicant: Walmart Apollo, LLC, Bentonville, AR (US)

(72) Inventor: Ryan J. Giovacchini, Joplin, MO (US)

(21) Appl. No.: 18/656,106

(22) Filed: May 6, 2024

Related U.S. Application Data
(60) Provisional application No. 63/464,369, filed on May 5, 2023.

(51) Int. Cl. G01G 19/415; G06K 7/14; G06K 19/06

(52) U.S. Cl. CPC G01G 19/415; G06K 7/1404; G06K 19/06037

(57) ABSTRACT

A system is provided for use at an exit of a retail facility. The system includes a scanner, a floor scale, and a control circuit communicatively coupled to the scanner and the floor scale. The scanner is proximate to the exit of the retail facility and at a separate location than a point of sale checkout station of the retail facility. The scanner is configured to capture an electronic code associated with a receipt of items purchased at the retail facility. The floor scale is proximate to the scanner and is configured to weigh a portable carrier containing the items when the portable carrier is positioned on a surface of the floor scale. The control circuit determines whether an estimated total weight of the purchased items associated with the receipt matches within a threshold with an actual weight of the portable carrier received from the floor scale.

### CROSS REFERENCING OF RELATED APPLICATION

This invention claims priority to U.S. Provisional Application No. 63/464,369, filed May 5, 2023, entitled “Systems and Methods for Use at an Exit of a Retail Facility”, the entirety of which is incorporated herein.

### TECHNICAL FIELD

This invention relates generally to verifying items purchased prior to exiting a retail store.

### SUMMARY

Aspects of the disclosure provide a system and method for use at an exit of a retail facility. A scanner is implemented proximate the exit of the retail facility and at a separate location than a point of sale checkout station of the retail facility. The scanner is configured to capture an electronic code associated with a receipt of items purchased at the retail facility. A floor scale is implemented proximate to and communicationally coupled to the scanner, the floor scale configured to weigh a portable carrier containing the items when the portable carrier is positioned on a surface of the floor scale. A control circuit is communicationally coupled to the scanner and the floor scale. The control circuit is configured to determine whether an estimated total weight of the purchased items associated with the receipt matches within a threshold with an actual weight of the portable carrier received from the floor scale.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is an exemplary a block diagram illustrating a system for use at an exit of a retail facility.

FIG. 2 is an exemplary flow diagram illustrating a process or method for use at an exit of a retail facility.

FIG. 3 is an exemplary flow diagram illustrating a process or method for use at an exit of a retail facility.

FIG. 4 is an exemplary flow diagram illustrating a process or method for use at an exit of a retail facility.

FIG. 5 is an exemplary block diagram illustrating a system for use at an exit of a retail facility.

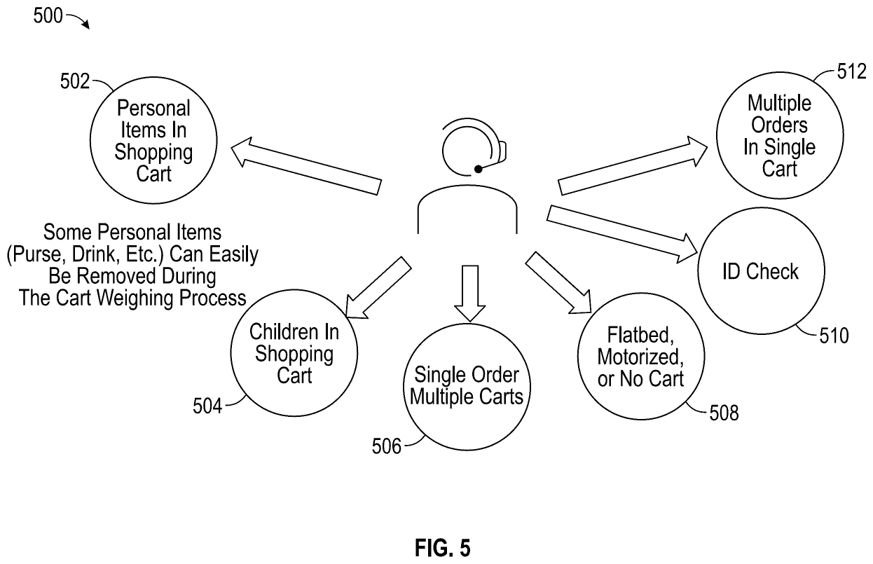

FIG. 6 is an exemplary diagram illustrating three item categories.

FIG. 7 is an exemplary diagram illustrating a floor scale and scanner.

FIG. 8 is an exemplary diagram illustrating a rearward positioning of additional floor scales.

FIG. 9 is an exemplary diagram illustrating a system for use at an exit of a retail facility.

FIG. 10 is an exemplary diagram illustrating a floor scale.

FIG. 11 is an exemplary diagram illustrating a system for use at an exit of a retail facility.

Corresponding reference characters indicate corresponding parts throughout the drawings.

### DETAILED DESCRIPTION

Generally speaking, pursuant to various embodiments, systems, apparatuses and methods are provided herein useful for reducing shrink, optimizing use of labor resources, and/or enhancing customer experience at a retail facility. In some embodiments, a system for use at an exit of a retail facility includes a scanner proximate the exit of the retail facility and at a separate location than a point of sale checkout station of the retail facility. In some embodiments, the scanner captures an electronic code associated with a receipt of items purchased at the retail facility. Alternatively, or in addition to, the system may include a floor scale proximate to and communicationally coupled to the scanner. For example, the floor scale may weigh a portable carrier containing the items when the portable carrier is positioned on a surface of the floor scale. Alternatively, or in addition to, the system includes a control circuit communicationally coupled to the scanner and the floor scale. In some embodiments, the control circuit determines whether an estimated total weight of the purchased items associated with the receipt matches within a threshold with an actual weight of the portable carrier received from the floor scale.

In some embodiments, a method for use at an exit of at a retail facility includes capturing, by a scanner proximate the exit of the retail facility and at a separate location than a point of sale checkout station of the retail facility, an electronic code associated with a receipt of items purchased at the retail facility. Alternatively, or in addition to, the method may include weighing, by a floor scale proximate to and communicationally coupled to the scanner, a portable carrier containing the items when the portable carrier is positioned on a surface of the floor scale. Alternatively, or in addition to, the method may include determining, by a control circuit communicationally coupled to the scanner and the floor scale, whether an estimated total weight of the purchased items associated with the receipt matches within a threshold with an actual weight of the portable carrier received from the floor scale.

In illustrative non-limiting examples, the system and methods described herein may enable a fully automated self-checkout process experienced by customers at a retail facility. For example, automating the verification of customers' receipts and comparing purchases to the expected weight of their portable carriers (e.g., shopping carts and shopping baskets, to name a few) before leaving the retail facility results in a faster exit time. In some embodiments, a floor scale described herein may detect a vast majority of shrink by value (e.g., up to 91.5%). In some embodiments, the system and methods described herein may boast a high internal rate of return (IRR), with a 276% IRR for the first year and 376% IRR in year 5, or half an exemplary scale's lifespan.

In illustrative non-limiting examples, the system and methods described herein may reduce exit wait times of customers shopping at a retail facility by, for example, taking less than one (1) second to register a portable carrier's weight and less than five (5) seconds to scan a receipt out. The tolerance of the system can be adjusted, for example, for each item on the receipt; thereby improving accuracy and reducing false positives. As such, the systems and methods described here may address retail challenges, as it has the potential to reduce shrink, optimize use of labor resources, and/or enhance customers' satisfaction.

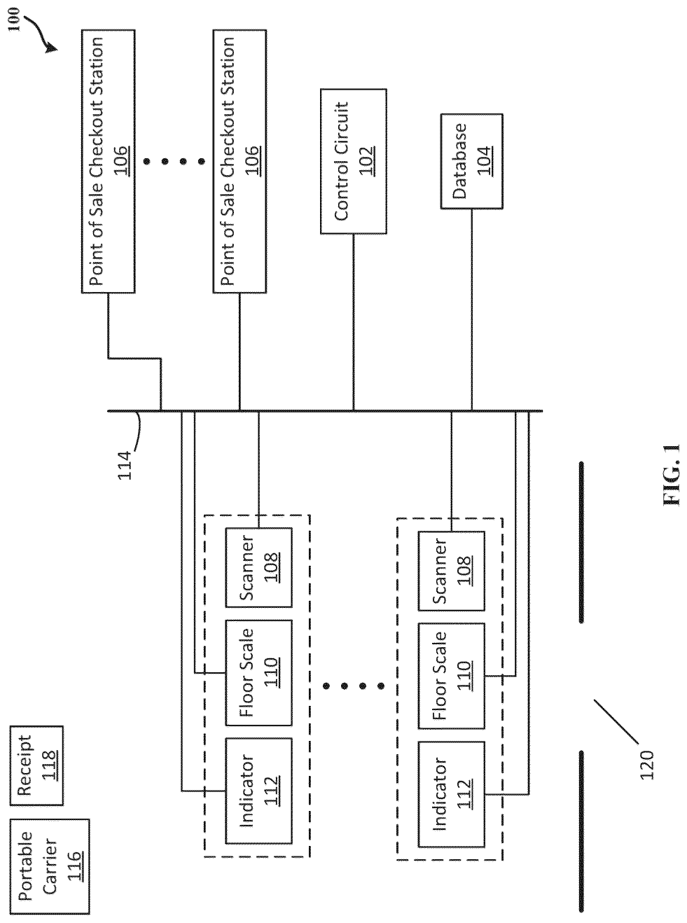

FIG. 1 illustrates a simplified block diagram of an example system 100 for use at an exit 120 of a retail facility. The system 100 includes one or more scanners 108 proximate the exit 120 of the retail facility and at a separate location than one or more point of sale (POS) checkout stations 106 of the retail facility. For example, the scanner/s 108 are closer to the exit 120 than to the POS checkout station/s 106. In another example, the scanner/s 108 are particularly used in conjunction with one or more floor scales 110 in order for a control circuit 102 to determine whether an estimated total weight of purchased items associated with a receipt matches within a threshold with an actual weight of a portable carrier 116 received from a floor scale 110. In some embodiments, the portable carrier 116 includes one of a shopping cart or a shopping basket.

In some embodiments, a scanner 108 captures an electronic code associated with a receipt 118 of items purchased at the retail facility. For example, the electronic code may include one of a QR code or a barcode. In another example, the receipt 118 may include one of a paper receipt or an electronic receipt presented or displayed via an electronic device (e.g., a smartphone, a smart watch, to name a few).

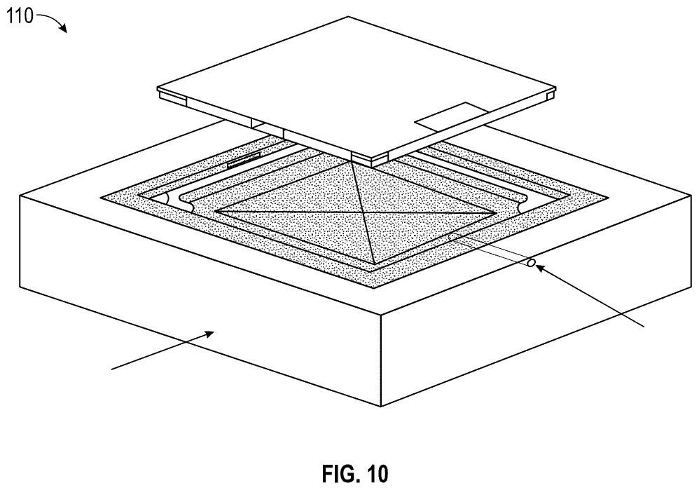

Alternatively, or in addition to, the system 100 may include one or more floor scales 110 proximate to and communicationally coupled to the scanner/s 108. In some embodiments, each floor scale 110 is paired with a particular scanner 108 and/or a particular indicator 112. For example, a floor scale 110 may weigh a portable carrier 116 containing purchased items when the portable carrier 116 is positioned on a surface of the floor scale 110. In an illustrative non-limiting example, the floor scale 110 may be configured to support a weight of a portable carrier 116 with multiple purchased items. In an illustrative non-limiting example, the floor scale 110 may support a maximum weight capacity of 1000 lbs. In another illustrative non-limiting example, the floor scale 110 may have a tolerance sufficient for accurately measuring weight of items placed in the portable carrier 116. In an illustrative non-limiting example, the floor scale 110 may have a tolerance of 0.1 lbs. In some embodiments, the floor scale 110 is embedded on a floor at the retail facility. FIG. 10 illustrates an example floor scale 110. In some embodiments, the floor scale 110 may be positioned on the floor with ramps leading to and from it at the retail facility. In some embodiments, the floor scale 110 may be any scale capable of capturing the weight of a portable carrier 116 when placed on a surface of the scale.

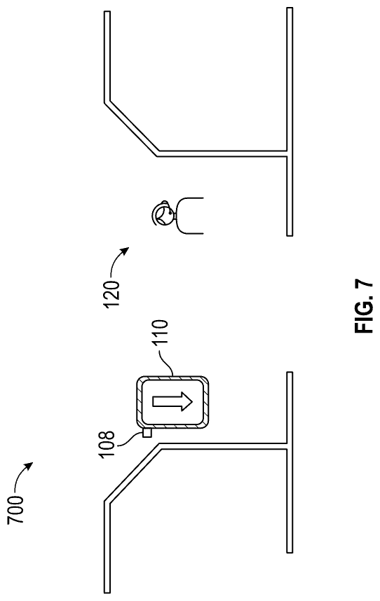

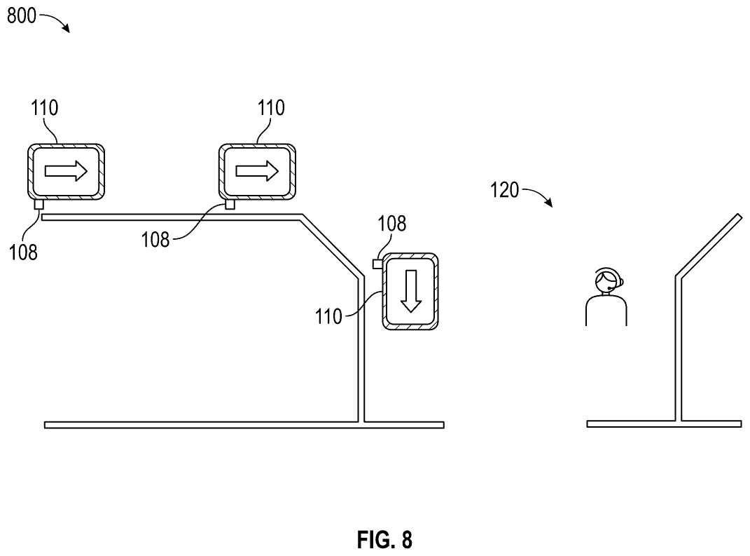

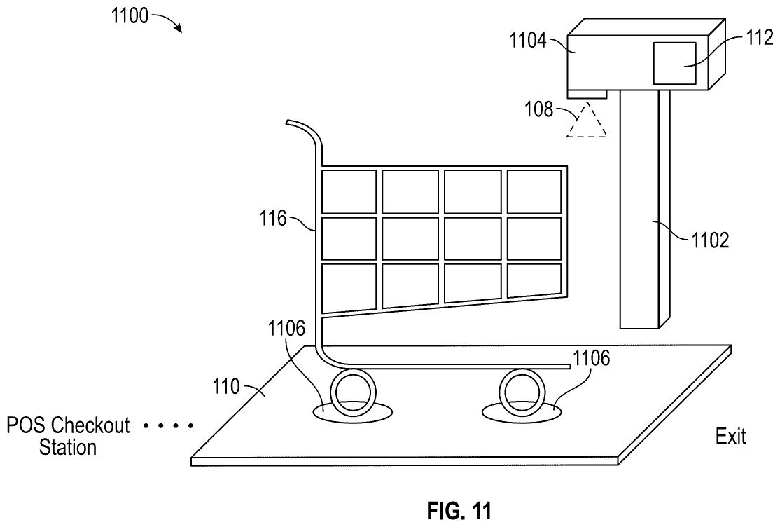

In some embodiments, an additional floor scale 110 may be positioned closer to the exit 120 than to the POS checkout station 106 and positioned at least one of rearward or alongside of a floor scale 110. FIG. 7 illustrates an example floor scale 110 and an example scanner 108 positioned closer to the exit 120. FIG. 8 illustrates rearward positioning of additional floor scales. In some embodiments, a scanner 108 may be coupled to a fixture mounted proximate to a floor scale 110. In some embodiments, a capture of an electronic code on a receipt 118 by the scanner 108 initiates an operation of the floor scale 110. FIG. 11 illustrates a simplified block diagram of an example system 1100 for use at an exit 120 of a retail facility. In an illustrative non-limiting example, an indicator 112 may guide a user to correctly position the portable carrier 116 onto the surface of the floor scale 110. For example, the indicator 112 may display a message indicating to a user to position the portable carrier 116 on the surface of the floor scale 110. In some embodiments, the floor scale 110 may include divots 1106 that position or secure the portable carrier 116 within the surface of the floor scale 110. In some embodiments, the scanner 108 may be integrated with the indicator 112. In some embodiments, the integrated scanner and indicator 1104 may be coupled to a fixture 1102 mounted proximate to the floor scale 110.

Alternatively, or in addition to, the system 100 includes a control circuit 102 communicationally coupled to the scanner/s 108 and/or the floor scale/s 110. In some embodiments, the control circuit 102 determines whether an estimated total weight of purchased items associated with a receipt 118 matches within a threshold with an actual weight of a portable carrier 116 received from a floor scale 110. In some embodiments, the control circuit 102 may execute a software stored in a memory (not shown) that interfaces with the floor scale/s 110 and/or an inventory system stored in a database 104. In an illustrative non-limiting example, the control circuit 102 may use the database 104 to lookup the expected weight for all items listed on a receipt 118 and compare the total weight of the items plus the portable carrier's 116 weight to the weight measurement from the floor scale 110 to determine if it falls within a given threshold.

Alternatively, or in addition to, the system 100 may include one or more indicators 112. For example, an indicator 112 may display a result of a determination of the control circuit 102 on whether the estimated total weight of the purchased items associated with a receipt 118 matches within a threshold with the actual weight of the portable carrier. For example, the threshold may include +0.4 and/or −0.4. In another example, the threshold may include +0.1 and/or −0.1, +0.2 and/or −0.2, +0.3 and/or −0.3, +0.5 and/or −0.5, +0.4 and/or −0.2, +0.4 and/or −0.3, to name a few. In some embodiments, the indicator 112 includes one of a light emitting device or a display screen. In yet some embodiments, the indicator 112 is integrated with the scanner 108. In an illustrative non-limiting example, the control circuit 102 may cause an indicator 112 to convey an alert indicating that the estimated total weight of the purchased items associated with the receipt does not match within the threshold with the actual weight of the portable carrier. For example, the indicator 112 may light up red and/or display a message. In some embodiments, the alert is a signal summoning a retail associate to come towards a respective floor scale 110 associated with the indicator 112 that conveyed the alert.

In an illustrative non-limiting example, the summoning of the retail associate may allow the associate to determine the cause of the alert. For example, the alert may cause by one or more of the following: personal items in the portable carrier 116, children in the portable carrier 116, single order multiple portable carriers 116, unrecognized portable carriers 116 (e.g., flatbed and motorized vehicle), no presence of a portable carrier 116, one or more items in the portable carrier 116 requiring identification check, and/or multiple orders in a single portable carrier 116.

In an illustrative non-limiting example, the control circuit 102 may cause an indicator 112 to convey a signal indicating that the estimated total weight of the purchased items associated with the receipt 118 matches within the threshold with the actual weight of the portable carrier 116. For example, the indicator 112 may light up green and/or display a message.

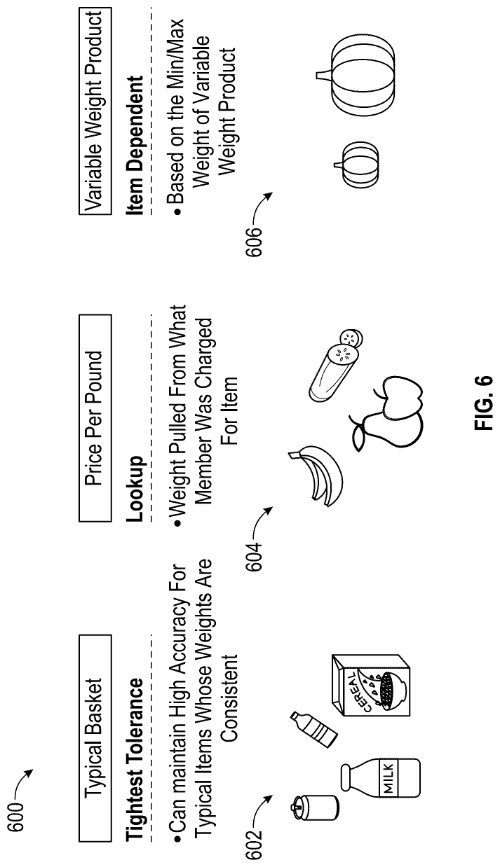

In an illustrative non-limiting example, the control circuit 102 may categorize the purchased items on the receipt 118 based on three categories (e.g., variable weight items/product 606, fixed weight items/typical basket 602, and price per weight/price per pound items 604). FIG. 6 illustrates three item categories. In some embodiments, the variable weight items/product 606 are price per item but may have noticeable weight variations while price per weight/price per pound items 604 are priced based on their weight. For example, the variable weight items/product 606 may include pumpkins, watermelons, and/or any item that can vary in size and/or weight but is sold per item. For example, price per weight/price per pound items 604 may include bananas, apples, deli meats/cheeses, rotisserie chicken, and/or anything that has a per pound or per weight price. In some embodiments, the fixed weight items/typical basket 602 are those items that do not vary significantly in weight from item to item. For example, the fixed weight items/typical basket 602 may include case of water, case of soda, cereal boxes, canned goods, to name a few.

In some embodiments, the control circuit 102 may adjust the threshold in response to the actual weight being outside the threshold relative to the estimated total weight based on at least one of a minimum or a maximum weight of an item in the items purchased associated with the receipt. In an illustrative non-limiting example, upon a determination of the control circuit 102 that one or more of the items listed on the receipt 118 are part of the variable weight items/product category 606, the threshold is increased by a value matching one that has been determined for the variable weight items/product category 606. For example, an item on the receipt 118 may be associated with the variable weight items/product category 606, which are those products whose weight varies substantially from one item to another item of same product (e.g., pumpkins, squash, to name a few).

In an illustrative non-limiting example, the item on the receipt 118 may be listed as a single pumpkin. In such example, when the weights for the items are looked up in the database 104 by the control circuit 102, the threshold may be adjusted or increased from the standard threshold (or a default threshold) by a tolerance value associated with the variable weight items/product category 606. For example, if the standard threshold is may be 0.4 lbs, then the control circuit 102 may adjust or increase the standard threshold with a tolerance value associated with pumpkins. For example, if the tolerance value associated with pumpkins is 0.2 lbs and the standard threshold is 0.4 lbs, the resulting adjusted threshold may be 0.6 lbs. In an illustrative non-limiting example, the tolerance value for pumpkins may be determined by the control circuit 102 by determining the weight distribution of 1,000 pumpkins representative of those being sold in the retail facilities and determining the corresponding minimum, maximum and average weights. For example, the threshold may be adjusted based on the average weight of the 1,000 pumpkins plus the difference between the average weight and the 90th percentile weight of the 1,000 pumpkins. In some embodiments, the control circuit 102 may determine a total respective weight associated with items on the receipt 118 that are belonging to the variable weight items/product category 606 based on averaging the weights determined for each item belonging to the variable weight items/product category 606. For example, if a squash and a pumpkin are on the receipt 118, the control circuit 102 may take the average of the corresponding tolerance values associated with the squash and the pumpkin to determine the amount the standard threshold is to be adjusted.

In some embodiments, the control circuit 102 may adjust the threshold into a tighter tolerance in response to the actual weight being outside the threshold relative to the estimated total weight based on the purchased items on the receipt 118 being in the fixed weight items/typical basket 602 category. For example, if all the items on the receipt 118 are associated with the fixed weight items/typical basket category 602, the control circuit 102 may adjust the standard threshold to a threshold value that corresponds to a tightest threshold. In some embodiments, the tightest threshold may be based on the accuracy of the floor scale 110 being used as part of the system described herein as well as the accuracy of the floor scale 110 used when creating the weight data stored in the database 104 that is being used to determine the estimated weight of the portable carrier 116.

In yet some embodiments, the control circuit 102 may adjust the threshold in response to the actual weight being outside the threshold relative to the estimated total weight based on the weight pulled from what the customer was charged for those items in the price per weight/price per pound items 604 category. For example, the control circuit 102 may take the average weight of those items in the price per weight/price per pound items 604 category and adjust the standard threshold accordingly. In an illustrative non-limiting example, for items associated with the price per weight/price per pound items 604 category, the control circuit 102 may check how much the receipt says the items cost. In some embodiments, the control circuit 102 may perform a look up in the database 104 to determine the cost per pound of the items. Alternatively, or in addition to, the control circuit 102 may convert the price to pound (or weight) and use the resulting weight value when calculating the estimated portable carrier 116 weight.

In another illustrative non-limiting example, for items associated with the fixed weight items/typical basket category 602, the control circuit 102 may perform a look up in the database 104 to determine the corresponding weight for each item in the fixed weight items/typical basket category 602. The control circuit 102 may determine the total weight of the items on the receipt 118 that are in the fixed weight items/typical basket category 602 and use the resulting total weight when calculating the estimated portable carrier 116 weight.

In some embodiments, the control circuit 102 may determine the categories of the items on the receipt 118. Alternatively, or in addition, the control circuit 102 may determine a respective total weight for each category based on one or more methods described above. Alternatively, or in addition, the control circuit 102 may determine the estimated total weight of the portable carrier 116 by summing the determined respective total weights.

In yet some embodiments, when the weights of the items on the receipt 118 are being looked up, each item will fall into one of the three categories described above (e.g., variable weight items/product 606, fixed weight items/typical basket 602, and price per weight/price per pound items 604). If any of the items listed on the receipt 118 are part of the variable weight items/product category 606, then the standard threshold that is used will be increased to match an adjusted threshold that has been determined for that/those items. For example, if the standard threshold is 0.5 lbs and the adjusted threshold for purchased items having a similar item belonging to the variable weight items/product 606 is 0.8 lbs, then the control circuit 102 may use the adjusted threshold of 0.8 lbs to determine whether an estimated total weight of the purchased items associated with the receipt 118 matches with an actual weight of the portable carrier 116 received from the floor scale 110.

In some embodiments, the control circuit 102, the database 104, the scanner/s 108, the floor scale/s 110, the indicator/s 112, and/or the POS checkout station/s 106 are communicationally coupled via a communication network 114. For example, the communication network 114 may include a cloud network, a local area network, a wired network, and/or a wireless network, to name a few.

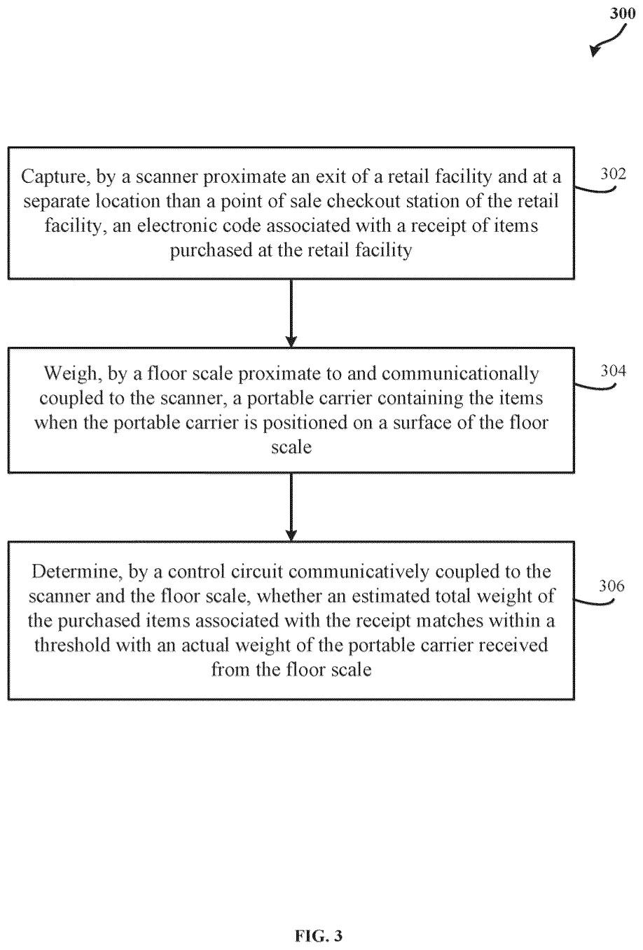

FIG. 3 shows a flow diagram of an example process or method 300 for use at an exit 120 of a retail facility in accordance with some embodiments. The method 300 includes, at step 302, capturing, by a scanner 108 proximate the exit 120 of the retail facility and at a separate location than a point of sale (POS) checkout station 106 of the retail facility, an electronic code associated with a receipt 118 of items purchased at the retail facility. Alternatively or in addition to, the method 300 may, at step 304, include weighing, by a floor scale 110 proximate to and communicationally coupled to the scanner 108, a portable carrier 116 containing the items when the portable carrier 116 is positioned on a surface of the floor scale 110. Alternatively or in addition to, the method 300 may include, at step 306, determining, by a control circuit 102 communicationally coupled to the scanner 108 and the floor scale 110, whether an estimated total weight of the purchased items associated with the receipt 118 matches within a threshold with an actual weight of the portable carrier 116 received from the floor scale 110.

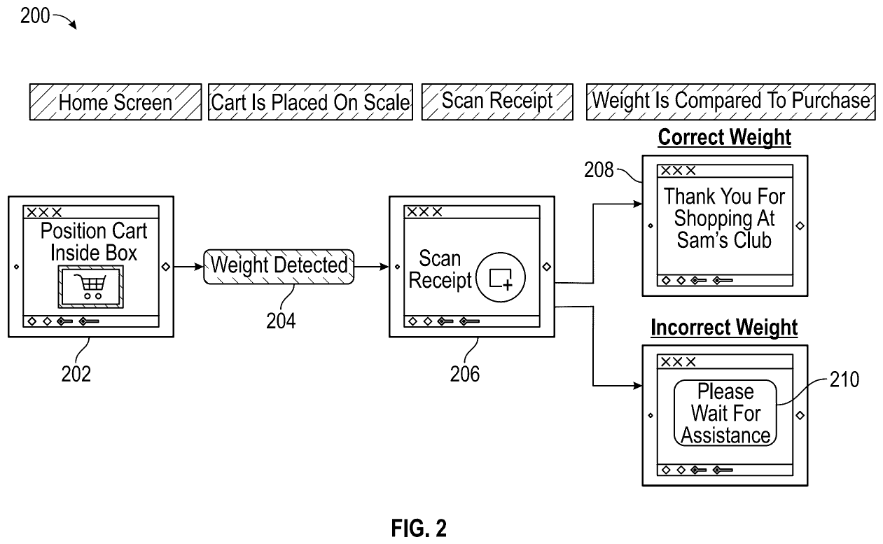

FIG. 2 shows a flow diagram of an example process or method 200 for use at an exit 120 of a retail facility in accordance with some embodiments. The method 200 includes, at step 202, displaying a message on an indicator 112 indicating to position a portable carrier 116 inside a box or marked perimeter on a surface of the floor scale 110. Alternatively or in addition to, the method 200 may include, at step 204, weighing, by the floor scale 110, the portable carrier 116. In some embodiments, a control circuit 102 may receive the actual weight of the portable carrier 116. Alternatively or in addition to, the method 200 may include, at step 206, displaying another message on the indicator 112 to scan a receipt 118 in response to detecting that a weight is being captured by the floor scale 110. In some embodiments, the control circuit 102 may receive the estimated total weight of the purchased items associated with the receipt 118. In some embodiments, the control circuit 102 determines whether the estimated total weight of the purchased items associated with the receipt 118 matches within a threshold with the actual weight of the portable carrier 116 received from the floor scale 110. Alternatively or in addition to, the method 200 may include, at step 208, in response to the estimated total weight matching within the threshold with the actual weight, displaying on the indicator 112 a message corresponding to an indication that there is no discrepancy between the estimated total weight and the actual weight. For example, the message include thanking the customer for shopping at the retail facility. In some embodiments, a retail facility includes a retail store, a distribution center, and/or a fulfillment center, to name a few. Alternatively or in addition to, the method 200 may include, at step 210, in response to the estimated total weight not matching within the threshold with the actual weight, displaying on the indicator 112 a message indicating to wait for an assistance from a retail associate. In some embodiments, the indicator 112 may display a flashing light signaling to a retail associate to go towards a respective scanner 108 and/or a respective floor scale 110 associated with the indicator 112.

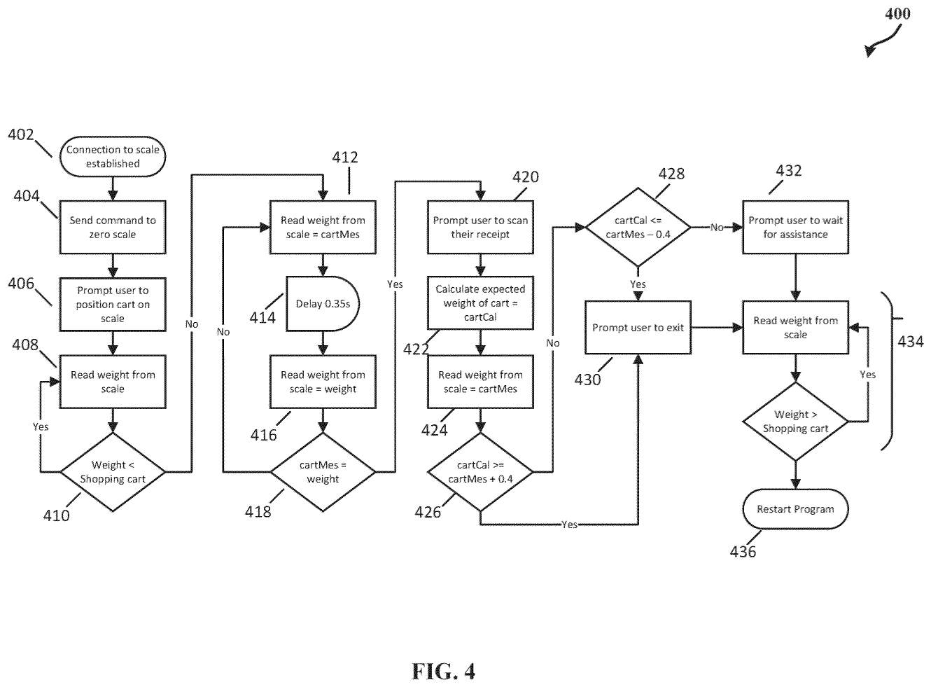

FIG. 4 shows a flow diagram of an example process or method 400 for use at an exit 120 of a retail facility in accordance with some embodiments. The method 400 includes, at step 402, establishing, by a control circuit 102, a connection with a floor scale 110. Alternatively or in addition to, the method 400 may include, at step 404, sending, by the control circuit 102, a command to zero the floor scale 110. Alternatively or in addition to, the method 400 may include, at step 406, prompting, by the control circuit 102 via the indicator 112, a user to position the portable carrier 116 on the floor scale 110. Alternatively or in addition to, the method 400 may include, at step 408, reading, by the control circuit 102, weight from the floor scale 110. Alternatively or in addition to, the method 400 may include, at step 410, determining, by the control circuit 102, whether the weight read from the floor scale 110 is less than the weight of an empty portable carrier 116. By one approach, if the weight read from the floor scale 110 is less, the weight from the floor scale 110 is reread again. By one approach, if the weight read from the floor scale 110 is equal or greater, setting, by the control circuit 102, the read weight to correspond to the actual weight of the portable carrier 116 (e.g., cartMes). Alternatively or in addition to, the method 400 may include, at step 414, delaying, by the control circuit 102, for a predetermined period of time (e.g., 0.35 seconds or any suitable time that is less than 1 minute) another rereading of the weight. Alternatively or in addition to, the method 400 may include, at step 416, determining, by the control circuit 102, whether the most recent reading of the weight is equal to the previous reading. Alternatively or in addition to, the method 400 may include, at step 420, prompting a user to scan a receipt 118 in response to the most recent reading of the weight being equal to the previous reading of the weight. Alternatively or in addition to, the method 400 may include repeating step 412 in response to the most recent reading of the weight not being equal to the previous reading of the weight.

Alternatively or in addition to, the method 400 may include, at step 422, calculating, by the control circuit 102, expected or estimated weight of the portable carrier 116 based on the items associated with the scanned receipt. Alternatively or in addition to, the method 400 may include, at step 424, taking, by the control circuit 102, another reading of the weight from the floor scale 110. Alternatively or in addition to, the method 400 may include, at step 426, determining, by the control circuit 102, whether the expected or estimated weight of the portable carrier 116 is equal to or greater than the actual read weight of the portable carrier 116 from the floor scale 110 plus a first threshold (e.g., +0.4, +0.3, +0.2, +0.1, +0.5, to name a few). Alternatively or in addition to, the method 400 may include, at step 430, prompting, by the control circuit 102, the user to exit the retail facility in response to the expected or estimated weight being equal to or greater than the actual read weight plus the first threshold.

Alternatively or in addition to, the method 400 may include, at step 428, determining, by the control circuit 102, whether the expected or estimated weight of the portable carrier 116 is equal to or less than the actual read weight of the portable carrier 116 from the floor scale 110 minus a second threshold (e.g., −0.4, −0.3, −0.2, −0.1, −0.5, to name a few) in response to the expected or estimated weight not being equal to or greater than the actual read weight plus the first threshold. Alternatively or in addition to, the method 400 may include, at step 430, prompting, by the control circuit 102, the user to exit the retail facility in response to the expected or estimated weight being equal to or less than the actual read weight minus the second threshold.

Alternatively or in addition to, the method 400 may include, at step 432, prompting, by the control circuit 102, the user to wait for assistance from a retail associate or cause an alert as previously describe above in response to the expected or estimated weight not being equal to or less than the actual read weight minus the second threshold.

Alternatively or in addition to, the method 400 may include, at step 434, in response to the retail associate determining the cause of the alert or the discrepancy between the estimated weight and the actual weight or the user has been prompted to exit the retail facility, the control circuit 102 calibrates the floor scale 110 in preparation for the next reading of another portable carrier 116. For example, the step 434 may include reading of the weight from the floor scale 110 and determining whether the read weight is greater than the empty weight of the portable carrier 116. By one approach, if the read weight is not greater than the empty weight of the portable carrier 116, the user interface or the program associated the indicator 112 is restarted by the control circuit 102 at step 436.

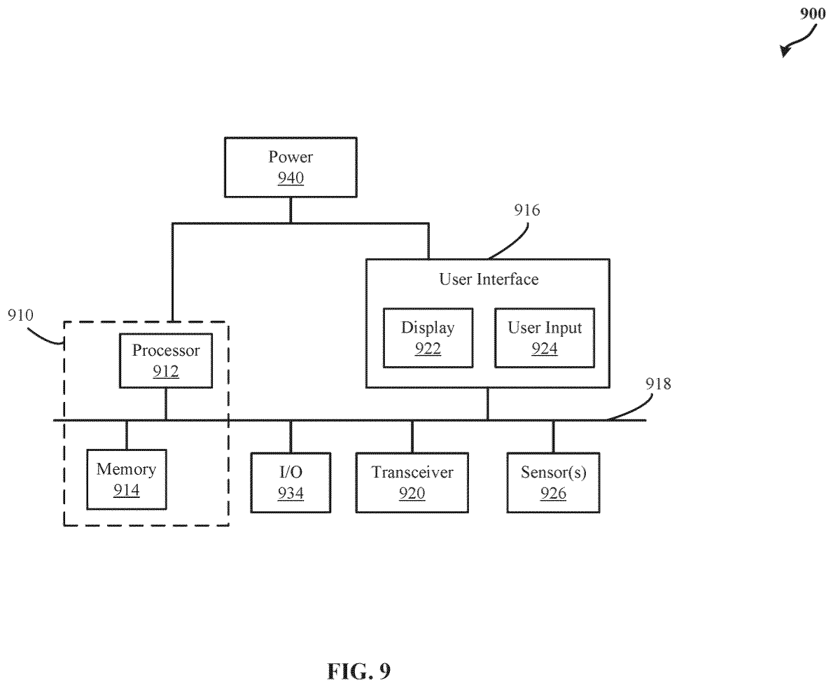

Further, the circuits, circuitry, systems, devices, processes, methods, techniques, functionality, services, servers, sources and the like described herein may be utilized, implemented and/or run on many different types of devices and/or systems. FIG. 9 illustrates an exemplary system 900 that may be used for implementing any of the components, circuits, circuitry, systems, functionality, apparatuses, processes, or devices of the system 100 of FIG. 1, the method 200 of FIG. 2, the method 300 of FIG. 3, the method 400 of FIG. 4, the system 1100 of FIG. 11, and/or other above or below mentioned systems or devices, or parts of such circuits, circuitry, functionality, systems, apparatuses, processes, or devices. For example, the system 900 may be used to implement some or all of the system used at an exit of a retail facility, the indicator 112, the floor scale 110, the scanner 108, the point of sale (POS) checkout station 106, the control circuit 102, the database 104, and/or other such components, circuitry, functionality and/or devices. However, the use of the system 900 or any portion thereof is certainly not required.

By way of example, the system 900 may comprise a processor module (or a control circuit) 912, memory 914, and one or more communication links, paths, buses or the like 918. Some embodiments may include one or more user interfaces 916, and/or one or more internal and/or external power sources or supplies 940. The control circuit 912 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 912 can be part of control circuitry and/or a control system 910, which may be implemented through one or more processors with access to one or more memory 914 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 900 may be used to implement one or more of the above or below, or parts of, components, circuits, systems, processes and the like. For example, the system 900 may implement the system used at an exit of a retail facility with the control circuit 102 being the control circuit 912.

The user interface 916 can allow a user to interact with the system 900 and receive information through the system. In some instances, the user interface 916 includes a display 922 and/or one or more user inputs 924, such as buttons, touch screen, track ball, keyboard, mouse, etc., which can be part of or wired or wirelessly coupled with the system 900. Typically, the system 900 further includes one or more communication interfaces, ports, transceivers 920 and the like allowing the system 900 to communicate over a communication bus, a distributed computer and/or communication network (e.g., a local area network (LAN), the Internet, wide area network (WAN), etc.), communication link 918, other networks or communication channels with other devices and/or other such communications or combination of two or more of such communication methods. Further the transceiver 920 can be configured for wired, wireless, optical, fiber optical cable, satellite, or other such communication configurations or combinations of two or more of such communications. Some embodiments include one or more input/output (I/O) interface 934 that allow one or more devices to couple with the system 900. The I/O interface can be substantially any relevant port or combinations of ports, such as but not limited to USB, Ethernet, or other such ports. The I/O interface 934 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 926 to provide information to the system and/or sensor information that is communicated to another component, such as the indicator 112, the floor scale 110, the scanner 108, the point of sale (POS) checkout station 106, the control circuit 102, the database 104, etc. The sensors can include substantially any relevant sensor, such as temperature sensors, distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 900 comprises an example of a control and/or processor-based system with the control circuit 912. Again, the control circuit 912 can be implemented through one or more processors, controllers, central processing units, logic, software and the like. Further, in some implementations the control circuit 9512 may provide multiprocessor functionality.

The memory 914, which can be accessed by the control circuit 912, typically includes one or more processor readable and/or computer readable media accessed by at least the control circuit 912, and can include volatile and/or nonvolatile media, such as RAM, ROM, EEPROM, flash memory and/or other memory technology. Further, the memory 914 is shown as internal to the control system 910; however, the memory 914 can be internal, external or a combination of internal and external memory. Similarly, some or all of the memory 914 can be internal, external or a combination of internal and external memory of the control circuit 912. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network. The memory 914 can store code, software, executables, scripts, data, content, lists, programming, programs, log or history data, user information, customer information, product information, and the like. While FIG. 9 illustrates the various components being coupled together via a bus, it is understood that the various components may actually be coupled to the control circuit and/or one or more other components directly.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for use at an exit of a retail facility comprising:
a scanner proximate the exit of the retail facility and at a separate location than a point of sale checkout station of the retail facility, the scanner configured to capture an electronic code associated with a receipt of items purchased at the retail facility;
a floor scale proximate to and communicationally coupled to the scanner, the floor scale configured to weigh a portable carrier containing the items when the portable carrier is positioned on a surface of the floor scale; and
a control circuit communicationally coupled to the scanner and the floor scale, the control circuit configured to determine whether an estimated total weight of the purchased items associated with the receipt matches within a threshold with an actual weight of the portable carrier received from the floor scale.

2. The system of claim 1, further comprising an indicator configured to display a result of a determination on whether the estimated total weight of the purchased items associated with the receipt matches within the threshold with the actual weight of the portable carrier.

3. The system of claim 2, wherein the indicator comprises one of a light emitting device or a display screen.

4. The system of claim 2, wherein the indicator is integrated with the scanner.

5. The system of claim 1, wherein the portable carrier comprises one of a shopping cart or a shopping basket.

6. The system of claim 1, wherein the floor scale is embedded on a floor at the retail facility.

7. The system of claim 1, wherein the electronic code comprises one of a QR code or a barcode.

8. The system of claim 1, wherein an additional floor scale positioned closer to the exit than to the point of sale checkout station and positioned at least one of rearward or alongside of the floor scale.

9. The system of claim 1, wherein the control circuit is further configured to cause an indicator to convey an alert indicating that the estimated total weight of the purchased items associated with the receipt does not match within the threshold with the actual weight of the portable carrier.

10. The system of claim 9, wherein the alert is a signal summoning a retail associate to come towards the floor scale.

11. The system of claim 1, wherein the control circuit is further configured to cause an indicator to convey a signal indicating that the estimated total weight of the purchased items associated with the receipt matches within the threshold with the actual weight of the portable carrier.

12. The system of claim 1, wherein the control circuit is further configured to adjust the threshold in response to the actual weight being outside the threshold relative to the estimated total weight based on at least one of a minimum or a maximum weight of an item in the items purchased associated with the receipt, wherein the item is associated with a category of products whose weight varies substantially from one item to another item of same product.

13. The system of claim 1, wherein the scanner is coupled to a fixture mounted proximate to the floor scale.

14. The system of claim 1, wherein a capture of the electronic code by scanner initiates an operation of the floor scale.

15. The system of claim 1, wherein an indicator guides a user to correctly position the portable carrier onto the surface of the floor scale.

16. The system of claim 1, wherein the floor scale comprises divots that position the portable carrier within the surface of the floor scale.

17. A method for use at an exit of at a retail facility comprising:
capturing, by a scanner proximate the exit of the retail facility and at a separate location than a point of sale checkout station of the retail facility, an electronic code associated with a receipt of items purchased at the retail facility;
weighing, by a floor scale proximate to and communicationally coupled to the scanner, a portable carrier containing the items when the portable carrier is positioned on a surface of the floor scale; and
determining, by a control circuit communicationally coupled to the scanner and the floor scale, whether an estimated total weight of the purchased items associated with the receipt matches within a threshold with an actual weight of the portable carrier received from the floor scale.

18. The method of claim 17, further comprising causing, by the control circuit, an indicator to convey an alert indicating that the estimated total weight of the purchased items associated with the receipt does not match within the threshold with the actual weight of the portable carrier.

19. The method of claim 18, wherein the alert is a signal summoning a retail associate to come towards the floor scale.

20. The method of claim 17, further comprising adjusting, by the control circuit, the threshold in response to the actual weight being outside the threshold relative to the estimated total weight based on at least one of a minimum or a maximum weight of an item in the items purchased associated with the receipt, wherein the item is associated with a category of products whose weight varies substantially from one item to another item of same product.
